(19) United States
(12) Patent Application Publication
(10) Pub. No.: US 2013/0016121 A1
(43) Pub. Date: Jan. 17, 2013

(54) Print Instruction Apparatus and Print Instruction Program

(71) Applicant: Juntaro Azuchi, Tokyo (JP)

(72) Inventor: Juntaro Azuchi, Tokyo (JP)

(21) Appl. No.: 13/535,223

(22) Filed: Jun. 27, 2012

(30) Foreign Application Priority Data
Jul. 13, 2011 (JP) JP2011-154412

(51) Int. Cl. G09G 5/00

(52) U.S. Cl. 345/619

(57) ABSTRACT

Disclosed is a print instruction apparatus, which makes it possible to conduct a print setting operation only by performing an intuitive touch panel action onto a print image currently displayed. The apparatus includes: an image display section to display a print image; an inputted information parsing section that parses signals outputted from the touch panel so as to specify a predetermined touch panel operation performed onto a predetermined area; a storage section to store correlating information for correlating the predetermined touch panel operation with a print setting; a print setting managing section to specify the print setting that corresponds to the predetermined touch panel operation; a display image creating section that creates image data representing the print image so as to update a print image currently displayed; and a print information creating section to create information representing an instruction for implementing a printing operation in conformity with the print setting.

This application is based on Japanese Patent Application NO. 20-154412 filed on Jul. 13, 2011, with Japan Patent Office, the entire content of which is hereby incorporated by reference.

### BACKGROUND OF THE INVENTION

The present invention relates to a print instruction apparatus and a print instruction program, and specifically relates to such a print instruction apparatus that is provided with a touch panel and relates to such a print instruction program that is to be executed in the print instruction apparatus concerned.

In recent years, smartphones and portable type terminal devices, such as a tablet type terminal device, etc., have been increasingly proliferated in the market, and it becomes possible for the user to make a terminal device perform various kinds of processing, merely by operating a touch panel provided therewith. For instance, the user can conducts operations for selecting a desired document, reducing a size of the document, enlarging the size of the document and turning over a page of the document, only by tapping the screen (slightly tapping the touch panel with his finger), performing a pinch-in action (clipping an image with two fingers and closing the two fingers), performing a pinch-out action (clipping the image with two fingers and opening the two fingers), swiping the screen (sliding his finger on the screen), respectively.

Further, with respect to another method for operating the touch panel, for instance, Tokkai 2009-053834 (Japanese Patent Application Laid-Open Publication) sets forth such the information display apparatus that is provided with a display section to display an image inputted into the screen, a determining section to determine whether or not the inputted image is the specific image established in advance and a control section to implement a job when the determining section determines that the inputted image is the specific image, so that the control section instructs the processing apparatus to implement the job determined corresponding to the specific image concerned and the control section discriminates a simplified symbol inputted from the touch panel so as to implement the processing, which is corresponds to the symbol above-discriminated.

In this connection, when the user intends to print the document currently displayed on the screen in a general purpose computer or the like, the user can make a print setting window emerge on the screen, so as to establish print conditions of the concerned document by selecting various kinds of desired items therefrom. However, as for the portable type terminal device having a relatively small sized screen, even if the print setting window is displayed on the screen, it has been difficult for the user to conduct operations for selecting various kinds of desired items from such a small sized window in order to establish the print conditions. Due to the background as abovementioned, the method for intuitively operating the touch panel to establish the print conditions has been demanded for the portable type terminal devices.

However, since the number of operations (finger actions) to be performed on the touch panel is relatively small, compared to the number of items to be established as the print settings, it is impossible to correlate the operations (finger actions) with the print setting items in a simple way. Further, since the operations (finger actions) abovementioned are possibly used for implementing the processing other than the printing operation, it is necessary to configure the system so as to make it possible to recognize them as the print setting operations. Still further, by employing the technology set forth in Tokkai 2009-053834, it would be possible to correlate the symbols established in advance with the print setting items. However, according to the abovementioned method, it is impossible for the user to intuitively operate the touch panel in order to establish the print conditions, and it is necessary to memorize the correspondence relationships between the symbols and the print setting items, resulting in an inconvenience for the user.

### SUMMARY OF THE INVENTION

To overcome the abovementioned drawbacks in conventional image forming apparatus, it is one of objects of the present invention to provide a print instruction apparatus and a print instruction program, each of which makes it possible to conduct a print setting operation only by performing an intuitive touch panel action onto a print image currently displayed.

Accordingly, at least one of the objects of the present invention can be attained by any one of the print instruction apparatuses and the non-transitory computer readable storage medium storing the print instruction program described as follows.

(1) According to a print instruction apparatus reflecting an aspect of the present invention, the print instruction apparatus that is provided with a touch panel, comprises: an image display section to display a print image of a document, serving as a print object, thereon; an inputted information parsing section that parses signals outputted from the touch panel, disposed on the image display section, so as to specify a predetermined touch panel operation performed onto a predetermined area located within the print image; a storage section to store correlating information for correlating the predetermined touch panel operation with a print setting that specifies a print condition or a finishing condition of the document, for every area correlated to the print image; a print setting managing section to specify the print setting that corresponds to the predetermined touch panel operation, performed onto a predetermined area and specified by the inputted information parsing section, while referring to the correlating information; a display image creating section that creates image data representing the print image, which corresponds to the print setting specified by the print setting managing section, so as to update a print image currently displayed on the image display section to the print image; and a print information creating section to create information representing an instruction for implementing a printing operation in conformity with the print setting specified by the print setting managing section.
(2) According to another aspect of the present invention, in the print instruction apparatus recited in item 1, the print instruction apparatus is provided with such an operating mode in which the predetermined touch panel operation, performed onto the predetermined area located within the print image, is to be registered; and in the operating mode, at a time when the predetermined touch panel operation is performed onto the predetermined area located within the print image: the display image creating section makes the image display section display a list of print settings, thereon; and the print setting managing section correlates the predetermined touch panel operation, performed onto the predetermined area, with a specific print setting selected from the list of print settings, so as to update the correlating information stored in the storage section.
(3) According to still another aspect of the present invention, in the print instruction apparatus recited in item 1, the predetermined touch panel operation, performed onto the predetermined area located within the print image, is to tap a peripheral edge side area of the print image; and the print setting, corresponding to the predetermined touch panel operation, is established as any one of stapling paper sheets at a tapped position and punching a paper sheet at a tapped position.
(4) According to still another aspect of the present invention, in the print instruction apparatus recited in item 1, the predetermined touch panel operation, performed onto the predetermined area located within the print image, is to swipe the touch panel so as to make a touched point rotate from a center of a side area of the print image, serving as an origin of rotation; and the print setting, corresponding to the predetermined touch panel operation, is established as changing a long side direction of a paper sheet.
(5) According to still another aspect of the present invention, in the print instruction apparatus recited in item 1, the predetermined touch panel operation, performed onto the predetermined area located within the print image, is to pinch an interval distance between a point, located at a center area of the print image, and another point, located at a edge portion of the print image, so as to change the interval distance pinched; and the print setting, corresponding to the predetermined touch panel operation, is established as changing a size of a paper sheet.
(6) According to still another aspect of the present invention, in the print instruction apparatus recited in item 1, the print image includes a document printing area within which the document is to be printed and a blank area located in periphery of the document printing area; the predetermined touch panel operation, performed onto the predetermined area located within the print image, is to pinch an interval distance between a point, located at a edge portion of the print image, and another point, located at the blank area in a vicinity of the edge portion, so as to change the interval distance pinched; and the print setting, corresponding to the predetermined touch panel operation, is established as changing the document printing area within which the document is to be printed.
(7) According to still another aspect of the present invention, in the print instruction apparatus recited in item 1, the predetermined touch panel operation, performed onto the predetermined area located within the print image, is to swipe the print image so as to make the print image split in either a horizontal direction or a vertical direction; and the print setting, corresponding to the predetermined touch panel operation, is established as an N-in-1 setting in which a plurality of pages is arranged into a single paper sheet.
(8) According to still another aspect of the present invention, in the print instruction apparatus recited in item 7, another predetermined touch panel operation, performed onto the predetermined area located within the print image, is to swipe the plurality of pages arranged into the single paper sheet; and the print setting, corresponding to the other predetermined touch panel operation, is established as a page allotment setting in which an arrangement order of the plurality of pages is made to change in accordance to an order of swiping the plurality of pages.
(9) According to still another aspect of the present invention, in the print instruction apparatus recited in item 1, the predetermined touch panel operation, performed onto the predetermined area located within the print image, is to swipe the print image so as to make the print image split in a short side direction of the print image; and the print setting, corresponding to the predetermined touch panel operation, is established as folding a paper sheet along a swiped line.
(10) According to still another aspect of the present invention, in the print instruction apparatus recited in item 1, the predetermined touch panel operation, performed onto the predetermined area located within the print image, is to swipe the print image along a side line of the print image; and the print setting, corresponding to the predetermined touch panel operation, is established as generating a binding margin along the side line swiped.
(11) According to a non-transitory computer readable storage medium reflecting yet another aspect of the present invention, the non-transitory computer readable storage medium stores a computer executable program to be executed in an apparatus that is provided with a touch panel mounted onto an image display section to display a print image of a document, serving as a print object, thereon, the program being executable by a computer to cause the computer to perform a process comprising: parsing signals outputted from the touch panel, so as to specify a predetermined touch panel operation performed onto a predetermined area located within the print image; referring to correlating information, stored in advance, for correlating the predetermined touch panel operation with a print setting that specifies a print condition or a finishing condition of the document, for every area correlated to the print image, so as to specify the print setting that corresponds to the predetermined touch panel operation, performed onto a predetermined area and specified in the above; creating image data representing the print image, which corresponds to the print setting above-specified, so as to update a print image currently displayed on the image display section to the print image; and creating information representing an instruction for implementing a printing operation in conformity with the print setting specified in the above.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows a schematic diagram indicating an exemplary outer appearance of a print instruction apparatus, embodied in the present invention;

FIG. 2 shows a block diagram indicating a module configuration of the print instruction apparatus, embodied in the present invention;

FIG. 3a, FIG. 3b, FIG. 3c and FIG. 3d show schematic diagrams indicating a method for operating a print instruction apparatus, embodied in the present invention;

FIG. 4 shows a schematic diagram and a table indicating an example of an area allotting map to be used for allotting areas to various kinds of print setting operations, respectively;

FIG. 5a and FIG. 5b show groups of schematic diagrams indicating examples of touch panel operations (corresponding to fundamental setting operations) to be performed onto a print instruction apparatus, embodied in the present invention;

FIG. 6a, FIG. 6b, FIG. 6c, FIG. 6d and FIG. 6e show groups of schematic diagrams indicating examples of touch panel operations (corresponding to layout operations) to be performed onto a print instruction apparatus, embodied in the present invention;

FIG. 7a, FIG. 7b, FIG. 7c, FIG. 7d, FIG. 7e and FIG. 7f show groups of schematic diagrams indicating examples of touch panel operations (corresponding to finishing operations) to be performed onto a print instruction apparatus, embodied in the present invention;

FIG. 8 shows a flowchart indicating a flow of print setting processing to be conducted in a print instruction apparatus, embodied in the present invention;

FIG. 9 shows a flowchart indicating a detailed flow of processing (processing flow 1) to be conducted in a print instruction apparatus, embodied in the present invention;

FIG. 10 shows a flowchart indicating a detailed flow of processing (processing flow 2) to be conducted in a print instruction apparatus, embodied in the present invention;

FIG. 11 shows a flowchart indicating a detailed flow of processing (processing flow 3) to be conducted in a print instruction apparatus, embodied in the present invention;

FIG. 12 shows a flowchart indicating a detailed flow of processing (processing flow 4) to be conducted in a print instruction apparatus, embodied in the present invention;

FIG. 13a, FIG. 13b, FIG. 13c and FIG. 13d show schematic diagrams indicating exemplified print setting registration screens to be displayed on a print instruction apparatus embodied in the present invention; and

FIG. 14 shows a flowchart indicating a print setting operation change processing to be conducted in a print instruction apparatus embodied in the present invention.

### DETAILED DESCRIPTION OF THE PREFERRED EMBODIMENT

As described in the background of the invention, in the apparatus provided with a touch panel, it is possible for the user to conduct various kinds of processing by performing various kinds of operations (finger actions), such as a tapping action, a pinch-in action, a pinch-out action, a swiping action, etc. However, in the case of the print processing, since the number of operations (finger actions) to be performed on the touch panel is relatively small, compared to the number of items to be established as the print settings, even if the operations (finger actions) and the print setting items are made to simply correlate with each other, it is difficult to establish the print setting items desired by the user concerned. Further, since the operations (finger actions) abovementioned are possibly used for implementing the processing other than the printing operation, it is necessary to configure the apparatus so as to make it possible to recognize them as the operations for establishing the print settings.

To overcome the abovementioned drawback in conventional apparatuses, according to an embodiment of the present invention, the panel touching actions, such as a tapping action, a pinch-in action, a pinch-out action, a swiping action, etc., and the print settings are correlated with each other and stored in a storage section for every one of areas corresponding to print images. Then, at the time when a predetermined panel touching action is performed for a predetermined area of the print image currently displayed, the apparatus, embodied in the present invention, specifies the print setting that corresponds to the predetermined panel touching action performed for the predetermined area, and updates the print image currently displayed according to the contents of the print setting above-specified, so as to implement the demanded printing operation.

According to the abovementioned embodiment of the present invention, only by performing a simplified and intuitive panel-touching action, such as a tapping action, a pinch-in action, a pinch-out action, a swiping action, etc., on the screen where the print image is displayed, it becomes possible for the user to conduct a desired print setting operation, resulting in an improvement of the usability and convenience of the user concerned.

### Embodiment

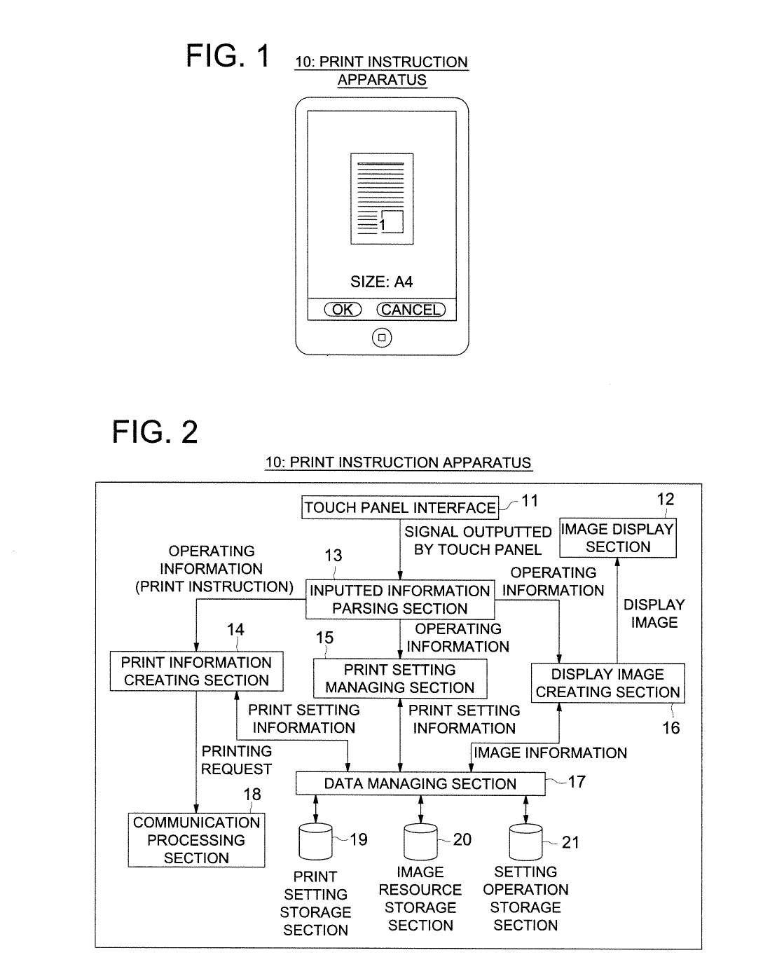

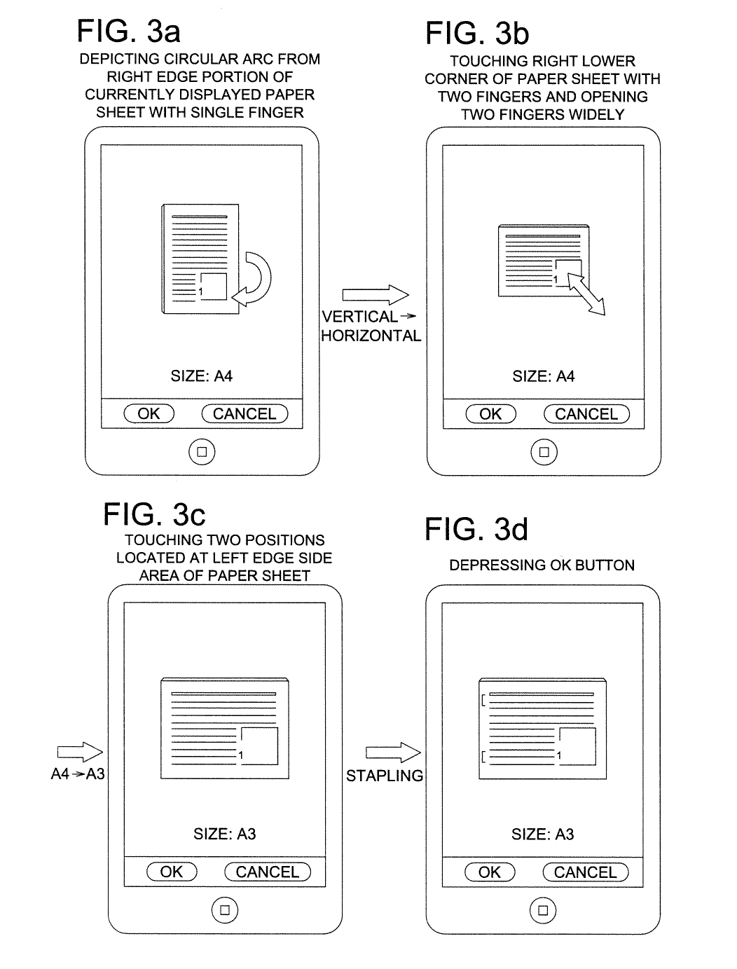

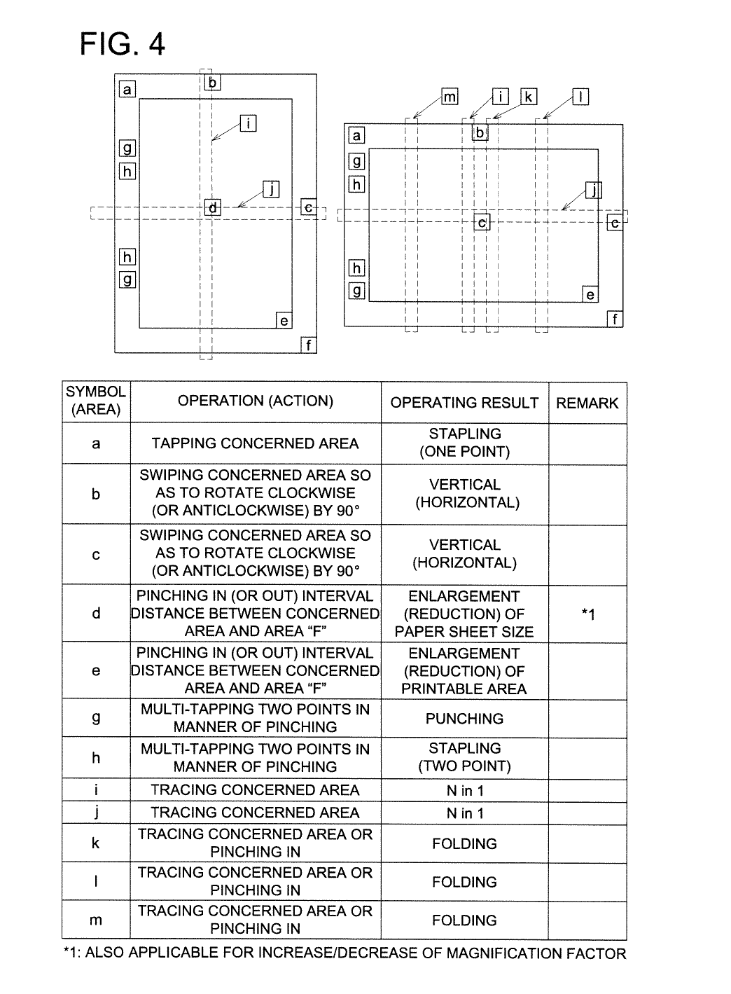

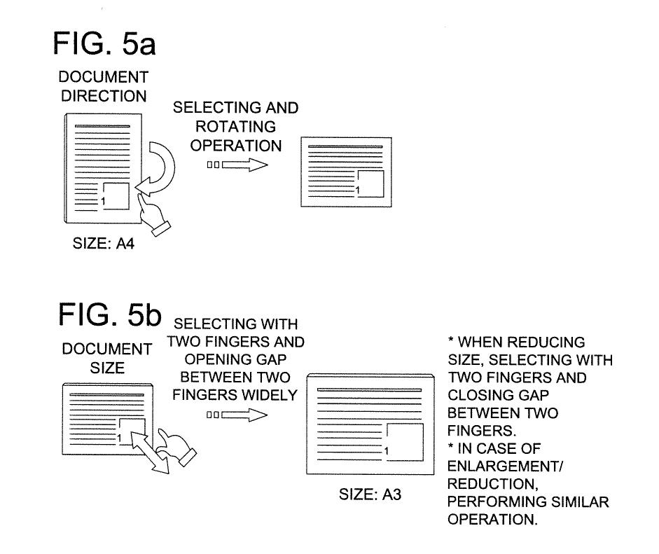

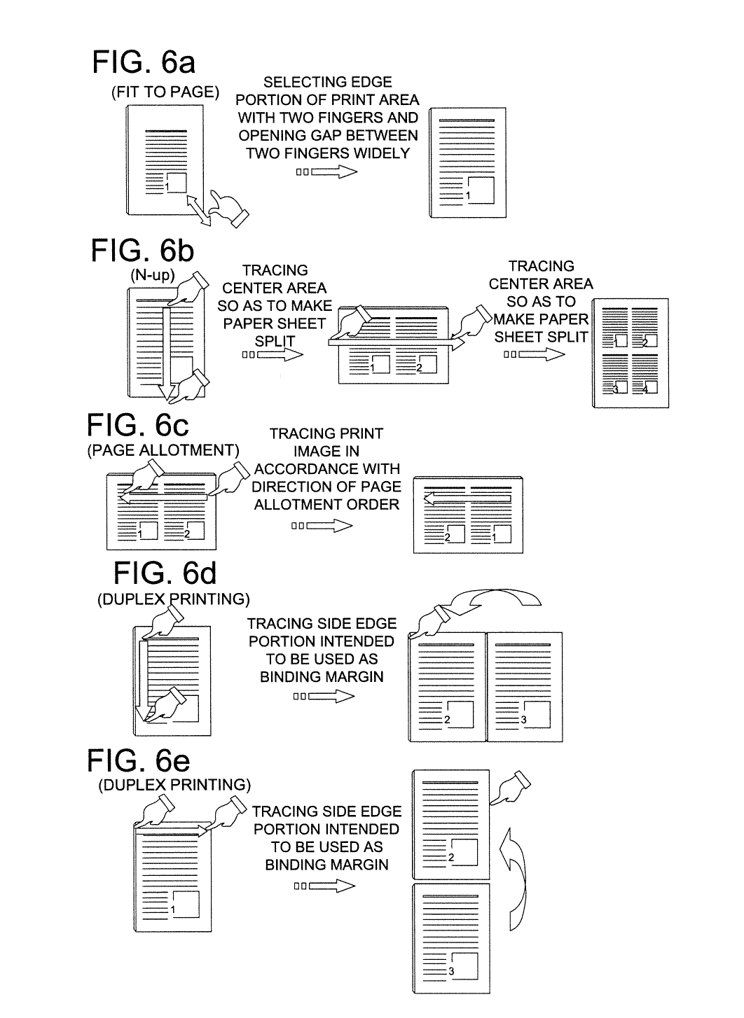

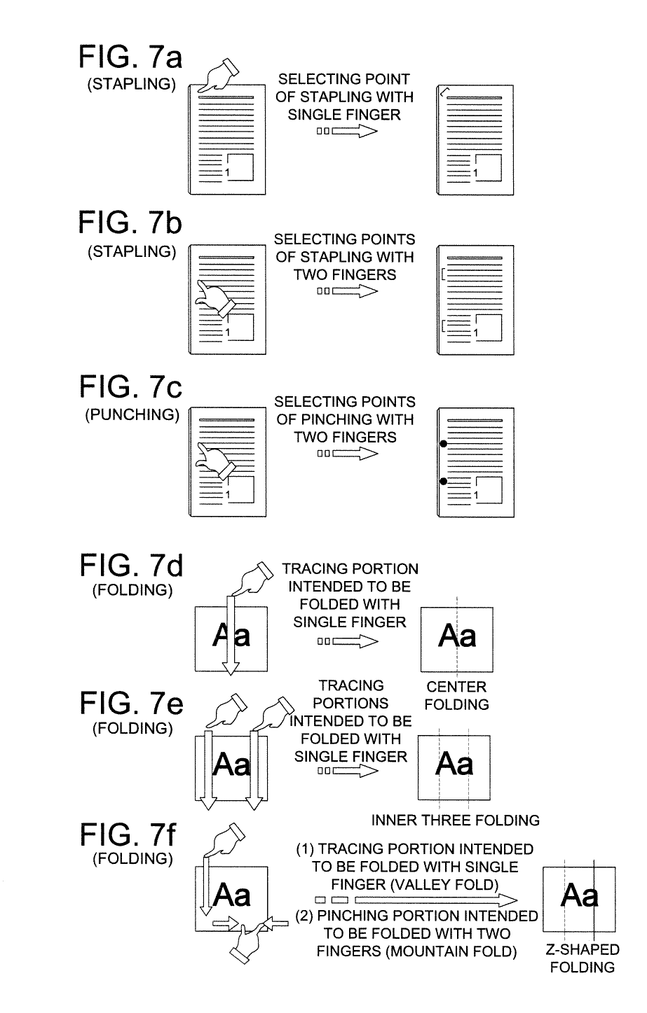

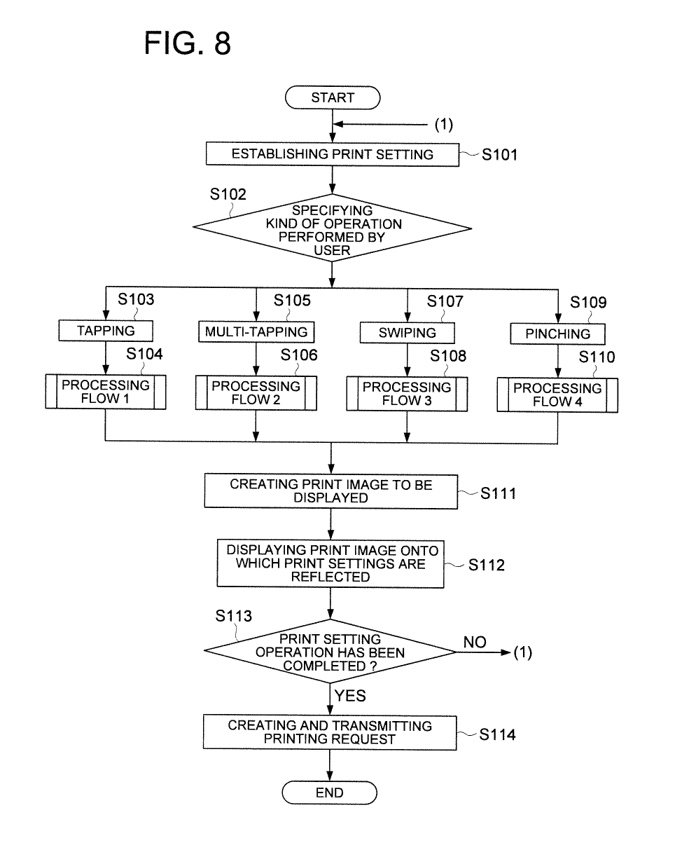

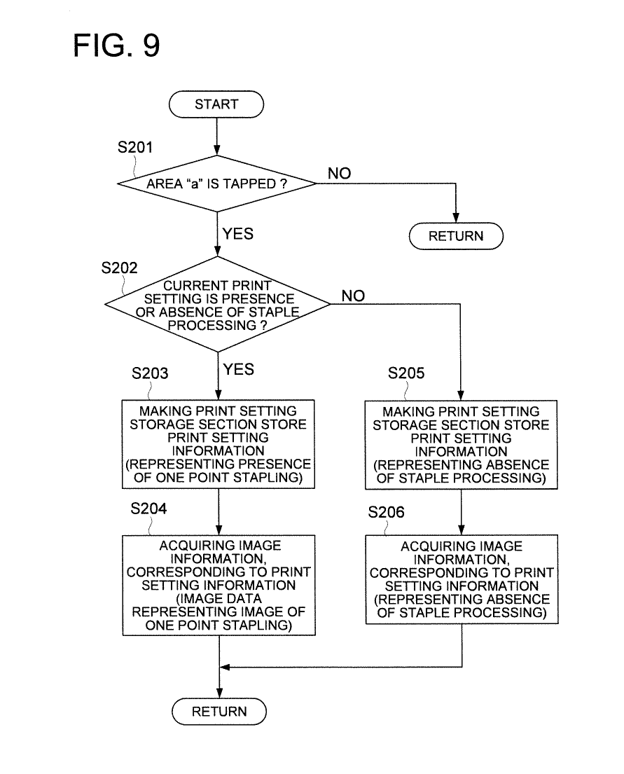

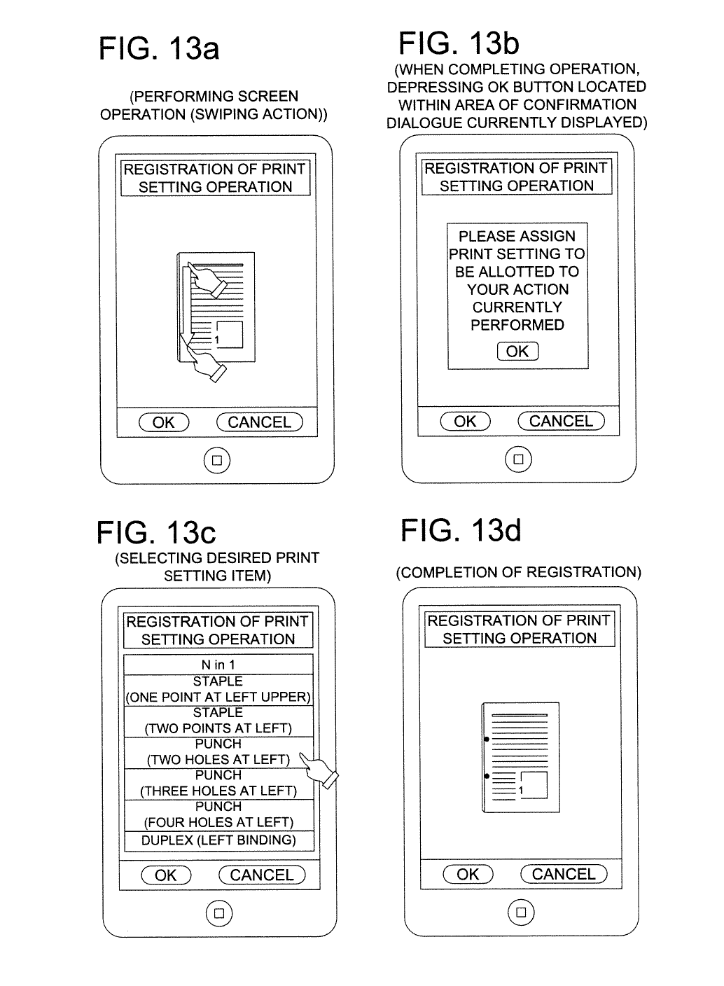

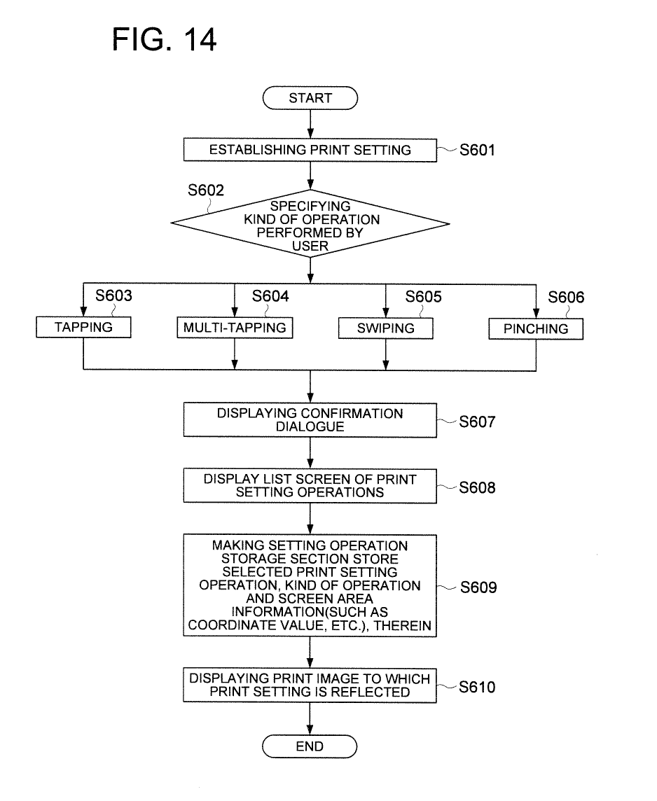

In order to describe the preferred embodiment of the present invention in detail, referring to FIG. 1 through FIG. 14, a print instruction apparatus and a print instruction program, embodied in the present invention, will be detailed in the following. FIG. 1 shows a schematic diagram indicating an outer appearance of a print instruction apparatus, embodied in the present invention, FIG. 2 shows a block diagram indicating a module configuration of the print instruction apparatus and FIG. 3a through FIG. 3d show schematic diagrams indicating a method for operating the print instruction apparatus, embodied in the present invention. Further, FIG. 4 shows a schematic diagram indicating an example of an area allotting mode to be used for a print setting operation. Still further, FIG. 5a and FIG. 5b, FIG. 6a through FIG. 6e and FIG. 7a through FIG. 7f show groups of schematic diagrams indicating details of fundamental setting operations, layout operations, post processing operations, respectively. Still further, FIG. 8 shows a flowchart indicating a flow of processing (print setting processing) to be conducted in the print instruction apparatus, embodied in the present invention, and FIG. 9 through FIG. 12 show flowcharts respectively indicating details of processing flow 1 through processing flow 4 included in the flowchart shown in FIG. 8. Still further, FIG. 13a through FIG. 13d show schematic diagrams indicating exemplified print setting registration screens to be displayed on the print instruction apparatus embodied in the present invention. Yet further, FIG. 14 shows a flowchart indicating a print setting operation change processing to be conducted in the print instruction apparatus embodied in the present invention.

In this connection, hereinafter, the term of “print image” is defined as such an image that illustratively indicates a finished state of a print product to be created by printing the document onto a paper sheet, and includes a flame image depicting the outer shape of the paper sheet and a document image to be printed onto the paper sheet concerned (either a document image to be actually printed, or a sample image is applicable). Further, the term of “print setting” is defined as setting information that specifies a print condition for implementing an operation for printing the document onto the paper sheet.

As shown in FIG. 1, a print instruction apparatus 10, embodied in the present invention, is provided with a multi touchable touch panel (in other words, a touch panel capable of simultaneously detecting two or more points touched by the user). For instance, a smartphone, a portable type terminal device, such as a tablet type terminal device, etc., and an image forming apparatus, such as an MFP (Multi-Functional Peripheral) that is provided with an operation panel capable of accepting multi touching operations to be performed by the user, etc., can be cited as the print instruction apparatus 10. Hereinafter, the portable type terminal device will be exemplified to describe the preferred embodiment of the present invention.

As shown in FIG. 2, the print instruction apparatus 10 is provided with a touch panel interface 11, an image display section 12, an inputted information parsing section 13, a print information creating section 14, a print setting managing section 15, a display image creating section 16, a data managing section 17, a communication processing section 18, a print setting storage section 19, an image resource storage section 20, a setting operation storage section 21, etc.

The touch panel interface 11 notify the inputted information parsing section 13 of a signal outputted from either a pressure sensitive touch panel or a electrostatic sensitive touch panel, which is disposed over the image display section 12.

The image display section 12 is constituted by any one or any combination of an EPD (Electrophoretic Display), a LCD (Liquid Crystal Display), an OELD (Organic Electro-Luminescence Display), etc., etc., so as to display an image (print image, etc.) represented by image information created by the display image creating section 16, thereon.

The inputted information parsing section 13 parses the information acquired from the touch panel interface 11 (signals outputted by the touch panel) to specify an operation performed by the user on the touch panel (hereinafter, referred to as a touch panel operation), and then, notifies the print information creating section 14, the print setting managing section 15 and the display image creating section 16 of the operating information representing the touch panel operation.

Receiving the operating information representing the touch panel operation that instructs a printing operation from the inputted information parsing section 13, the print information creating section 14 acquires print setting information, currently stored in the print setting storage section 19, through the data managing section 17, so as to create information instructing the printing operation (hereinafter, referred to as a printing request) based on the print setting information concerned, and then, notifies the communication processing section 18 of the printing request above-created.

Further, receiving the operating information representing the touch panel operation (such information that represents a fundamental setting operation, a layout operation, a finishing operation, etc., detailed later) from the inputted information parsing section 13, the print setting managing section 15 acquires correlating information, currently stored in the setting operation storage section 21, from the data managing section 17, so as to specify the print setting that corresponds to the touch panel operation, performed by the user on the touch panel, while referring to the correlating information concerned, and then notifies the data managing section 17 of the print setting information above-specified.

Still further, receiving the image data, currently stored in the image resource storage section 20, from the data managing section 17, the display image creating section 16 creates print data, representing a print image, based on the image data acquired, and transmits the print data above-created to the image display section 12. Yet further, when receiving the operating information from the inputted information parsing section 13, the display image creating section 16 modifies the print image based on the operating information acquired, and transmits the print data, representing the modified print image, to the image display section 12.

The data managing section 17 manages operations for inputting and outputting various kinds of data into/from the print setting storage section 19, the image resource storage section 20 and the setting operation storage section 21. Concretely speaking, the data managing section 17 conducts operations for: notifying the print setting managing section 15 of the correlating information, stored in the setting operation storage section 21; notifying the display image creating section 16 of the image information, stored in the image resource storage section 20; storing the print setting information, acquired from the print setting managing section 15, into the print setting storage section 19; notifying the print information creating section 14 of the print setting information, stored in the print setting storage section 19; and so on.

The communication processing section 18 is constituted by a NIC (Network Interface Card), a modem, etc., and communicates with an image forming apparatus, a printer controller, etc., which are coupled to each other through a network, in either the wired communication mode or the wireless communication mode, so as to transmit the printing request, notified by the print information creating section 14, to the image forming apparatus, a printer controller, etc., through the network concerned.

The print setting storage section 19 stores the print setting information currently established, therein. While, the image resource storage section 20 stores the image information (representing the print image currently created, and/or stock images that serve as original materials for creating a print image), therein. The setting operation storage section 21 stores the correlating information for correlating the touch panel operation (finger actions) with the print setting, therein.

In this connection, it is applicable that each of the inputted information parsing section 13, the print information creating section 14, the print setting managing section 15, the display image creating section 16, the data managing section 17, etc., is configured as hardware. Alternatively, it is also applicable that the print instruction apparatus 10 is provided with a control section, which is constituted by a CPU (Central Processing Unit) and storage devices including a ROM (Read Only Memory), a RAM (Random Access Memory), etc., and executes a print instruction program, so as to make the control section serve as each of the inputted information parsing section 13, the print information creating section 14, the print setting managing section 15, the display image creating section 16, the data managing section 17, etc.

Next, referring to schematic diagrams shown in FIG. 3a through FIG. 3d, the print setting method employing the print instruction apparatus 10 configured as abovementioned will be briefly described in the following.

Initially, the image display section 12 is made to display the print image. On that occasion, according to the present invention, in order to correlate the touch panel operation to be performed for the print image and the peripheral area thereof with the print setting, the print image is not displayed allover the screen. Accordingly, there exists the peripheral area surrounding the print image, from which the touch panel inputting operation is available. Therefore, when the touch panel operation is performed on an area that is positioned more outer than the print image and the peripheral area thereof, the touch panel operation currently performed can be regarded as that for a processing other than the print setting operation.

As shown in FIG. 3a, when a single finger of the user performs such a touch panel operation for depicting a circular arc from a right edge portion of the currently displayed paper sheet, serving as an original moving point, the inputted information parsing section 13 parses the signals outputted from the touch panel, and specifies the touch panel operation performed by the user as the print setting operation for rotating the direction of the paper sheet by 90°, and then, notifies the print setting managing section 15 and the display image creating section 16 of the print setting operation information representing the print setting operation above-specified. Receiving the print setting operation information, the print setting managing section 15 acquires the correlating information, stored in the setting operation storage section 21, through the data managing section 17, so as to specify the print setting, which corresponds to the print setting operation information concerned (herein, the print setting for setting the longitudinal side of the paper sheet at the horizontal direction) while referring to the correlating information above-acquired, and then, notifies the data managing section 17 of the print setting information above-specified. Receiving the print setting information, the data managing section 17 makes the print setting storage section 19 store the print setting information above-specified, therein. Further, acquiring the image information, stored in the image resource storage section 20, from the data managing section 17, the display image creating section 16 creates image data representing a print image to be printed onto the paper sheet, the direction of which is rotated by 90°, so as to make the image display section 12 display the print image based on the image data above-created, as shown in FIG. 3b.

Successively, when the user performs such a touch panel operation for touching the right lower corner of the paper sheet, currently displayed as shown in FIG. 3b, with his two fingers and opening the two fingers widely, the inputted information parsing section 13 parses the signals outputted from the touch panel, and specifies the touch panel operation, currently performed by the user, as the print setting operation for enlarging the image size of the paper sheet, and then, notifies the print setting managing section 15 and the display image creating section 16 of the print setting operation information representing the print setting operation above-specified. Receiving the print setting operation information, the print setting managing section 15 acquires the correlating information, stored in the setting operation storage section 21, through the data managing section 17, so as to specify the print setting, which corresponds to the print setting operation information concerned (herein, the print setting for changing the size of the paper sheet from A4 size to A3 size) while referring to the correlating information above-acquired, and then, notifies the data managing section 17 of the print setting information above-specified. Receiving the print setting information, the data managing section 17 makes the print setting storage section 19 store the print setting information above-specified, therein. Further, acquiring the image information, stored in the image resource storage section 20, from the data managing section 17, the display image creating section 16 creates image data representing a print image to be printed onto the paper sheet, the size of which is enlarged, so as to make the image display section 12 display the print image based on the image data above-created, as shown in FIG. 3c. In this connection, in the case of the operation for changing the paper sheet size, since the print image currently displayed is available for this purpose, it is also possible to create the print image based on the operating information notified from the inputted information parsing section 13.

Still successively, when the user performs such a touch panel operation for touching two positions located at the left edge side area of the paper sheet, currently displayed as shown in FIG. 3c, with his two fingers, respectively, the inputted information parsing section 13 parses the signals outputted from the touch panel, and specifies the touch panel operation, currently perforated by the user, as the print setting operation for stapling the paper sheets at the two positions located at the left edge side area of the paper sheet, and then, notifies the print setting managing section 15 and the display image creating section 16 of the print setting operation information representing the print setting operation above-specified. Receiving the print setting operation information, the print setting managing section 15 acquires the correlating information, stored in the setting operation storage section 21, through the data managing section 17, so as to specify the print setting, which corresponds to the print setting operation information concerned (herein, the print setting for stapling the paper sheets at the two positions located at the left edge side area of the paper sheet) while referring to the correlating information above-acquired, and then, notifies the data managing section 17 of the print setting information above-specified. Receiving the print setting information, the data managing section 17 makes the print setting storage section 19 store the print setting information above-specified, therein. Further, acquiring the image information, stored in the image resource storage section 20, from the data managing section 17, the display image creating section 16 creates image data representing a print image to be printed onto the paper sheet, in which the stapling positions are clearly indicated, so as to make the image display section 12 display the print image based on the image data above-created, as shown in FIG. 3d.

Yet successively, when the user performs such a touch panel operation for depressing the OK button, currently displayed within the screen as shown in FIG. 3d, the inputted information parsing section 13 parses the signals outputted from the touch panel, and specifies the touch panel operation, currently performed by the user, as the print setting operation for instructing the implementation of the printing operation, and then, notifies the print information creating section 14 of the print setting operation information representing the print setting operation above-specified. Receiving the print setting operation information, the print information creating section 14 acquires the current print setting information from the print setting storage section 19 through the data managing section 17, so as to create the printing request based on the print setting information, and then, notifies the communication processing section 18 of the printing request above-created. Then, the communication processing section 18 transmits the received printing request to the image forming apparatus.

Next, referring to the schematic diagrams shown in FIG. 4 through FIG. 7f, a concrete method for establishing the print setting will be detailed in the following. FIG. 4 shows a schematic diagram indicating an operating position and the print setting corresponding to the operating position concerned, and an outside frame in the schematic diagram indicates an outer appearance of the paper sheet, while an inside frame indicates a printing area of the paper sheet within which the document image is to be printed. Further, the schematic diagrams, shown in FIG. 5 through FIG. 7f, indicate various kinds of operations to be employed for establishing the print settings.

An area “a”, located in a left upper area of the print image, is to be used for instructing the stapling operation (a single point). For instance, as shown in FIG. 7a, when the user performs such a touch panel operation for touching the area “a”, located in the left upper area of the print image, with one of his fingers, the touch panel operation, currently performed by the user, is determined as the print setting operation for stapling the paper sheets at one point located at the left upper point of the paper sheet concerned.

Further, an area “b”, located in an upper side area of the print image, and an area “c”, located in a right side area of the print image, are to be used for instructing the direction of the paper sheet. For instance, as shown in FIG. 5a, when the user performs such a touch panel operation for touching the area “a”, located in the left upper area of the print image, with one of his fingers, and swiping the currently-touched single finger so as to rotating the print image in the right or left direction by 90°, the touch panel operation, currently performed by the user, is determined as the print setting operation for rotating the longitudinal edge side of the paper sheet from the vertical direction to the horizontal direction, or from the horizontal direction to the vertical direction.

Still further, an area “d”, located in substantially a center area of the print image, and an area “f”, located in a right lower corner area of the print image, are to be used for instructing the enlargement or reduction of the paper sheet size. For instance, as shown in FIG. 5b, when the user performs such a touch panel operation for touching the area “d”, located in substantially the center area of the print image, with one of his fingers while touching the area “f”, located in the right lower corner area of the print image, with another one of his fingers, and widening the distance between the two fingers concerned, the touch panel operation, currently performed by the user, is determined as the print setting operation for enlarging the size of the paper sheet, while, when the user performs such a touch panel operation for narrowing the distance between the two fingers concerned, the touch panel operation, currently performed by the user, is determined as the print setting operation for reducing the size of the paper sheet.

Still further, an area “e”, located in a right lower corner area of the document image, and an area “f”, located in a right lower corner area of the print image, are to be used for instructing the enlargement or reduction of the print area size. For instance, as shown in FIG. 6a, when the user performs such a touch panel operation for touching the area “e”, located in the right lower corner area of the document image, with one of his fingers while touching the area “f”, located in the right lower corner area of the print image, with another one of his fingers, and widening the distance between the two fingers concerned, the touch panel operation, currently performed by the user, is determined as the print setting operation for enlarging the size of the print area, while, when the user performs such a touch panel operation for narrowing the distance between the two fingers concerned, the touch panel operation, currently performed by the user, is determined as the print setting operation for reducing the size of the print area.

Still further, two areas “g”, respectively located in a left upper side area and a left lower side area of the print image, are to be used for instructing the punching operation. For instance, as shown in FIG. 7c, when the user performs such a touch panel operation for simultaneously tapping the two areas “g”, respectively located in the left upper side area and the left lower side area of the print image, with his two fingers (multi-tapping action), the touch panel operation, currently performed by the user, is determined as the print setting operation for punching two holes in the left side area of the paper sheet concerned.

Still further, two areas “h”, respectively located in a left upper side area and a left lower side area of the print image, are to be used for instructing the stapling operation for stapling the paper sheets at two points. For instance, as shown in FIG. 7b, when the user performs such a touch panel operation for simultaneously tapping the two areas “h”, respectively located in the left upper side area and the left lower side area of the print image, with his two fingers (multi-tapping action), the touch panel operation, currently performed by the user, is determined as the print setting operation for stapling the paper sheets at two points in the left side area of the paper sheet concerned.

Still further, an area “i”, vertically extended at substantially a center area of the print image as depicted by the broken lines, and an area “j”, horizontally extended at substantially a center area of the print image as depicted by the other broken lines, are to be used for instructing the N-in-1 operation for arranging plural pages within the paper sheet. For instance, as shown in FIG. 6b, when the user performs such a touch panel operation for tracing the center area in either substantially a vertical direction of the print image or substantially a horizontal direction of the print image, with one of his fingers, the touch panel operation, currently performed by the user, is determined as the print setting operation for arranging plural pages within the print area of the paper sheet concerned.

Still further, when the longitudinal side of the print image is displayed in a horizontal direction, an area “k”, vertically extended at substantially a center area of the print image and located at a position being slightly right side of the area “i” as depicted by the broken lines, is to be used for instructing the folding operation for folding the paper sheet. For instance, as shown in FIG. 6b, when the user performs such a touch panel operation for tracing substantially the center area in a vertical direction of the print image, with one of his fingers, the touch panel operation, currently performed by the user, is determined as the print setting operation for implementing the center folding in which the paper sheet is folded two at the center of the paper sheet concerned.

Still further, when the longitudinal side of the print image is displayed in a horizontal direction, an area “l”, vertically extended in the right area of the print image as depicted by the broken lines, and an area “m”, vertically extended in the left area of the print image as depicted by the other broken lines, are also to be used for instructing the folding operation for folding the paper sheet. For instance, as shown in FIG. 7e, when the user performs such a touch panel operation for tracing the print image twice in a vertical direction of the print image with one of his fingers, or performing the pinch-in action at the upper and lower portions with his two fingers, the touch panel operation, currently performed by the user, is determined as the print setting operation for implementing the inner three folding in which the paper sheet is folded three.

Yet further, as shown in FIG. 6c, although a corresponding area is not indicated in the schematic diagram shown in FIG. 4, when the user performs such a touch panel operation for tracing the print image, in which plural pages are aligned in the horizontal direction, in either a right direction or a left direction with one of his fingers, the touch panel operation, currently performed by the user, is determined as the print setting operation for designating the order for allotting the pages onto the paper sheet. Further, as shown in FIG. 6c, when the user performs such a touch panel operation for tracing the print image along any one of the upper, lower, left and light sides of the print image with one of his fingers, the touch panel operation, currently performed by the user, is determined as the print setting operation for implementing the duplex printing while setting the binding margin at the currently traced side. Still further, as shown in FIG. 7f, when the user performs such touch panel operations for tracing the print image along a vertical line at which the user intends to fold the paper sheet as the valley fold, while clipping a part of the print image at which the user intends to fold the paper sheet as the mountain fold, the combination of the touch panel operations, currently performed by the user, is determined as the print setting operation for folding the paper sheet into the Z-shaped folding.

In this connection, referring to the schematic diagrams shown in FIG. 4 through FIG. 7f, the touch panel operations for establishing various kinds of print settings in regard to the direction of the document, the size of the document, the print area, the N-in-1, the page allotment, the duplex printing, the staple processing, the punch processing and the fold processing have been described in the foregoing. However, it is needless to say that the scope of touch panel operations applicable in the present invention is not limited to the abovementioned examples.

Next, referring to the flowcharts shown in FIG. 8 through FIG. 12, the processing to be conducted by the print instruction apparatus 10 will be detailed in the following.

Initially, the user implements a predetermined operation so as to make the image display section 12 display a print image thereon. Then, when the user performs a predetermined touch panel operation for establishing a print setting (Step S101), the touch panel interface 11 notifies the inputted information parsing section 13 of signals outputted from the touch panel (positional information representing positions at which the user touches the touch panel), and then, the inputted information parsing section 13 parses the positional information to specify the operation performed by the user concerned (Step S102).

When the touch panel operation conducted by the user is the tapping action (Step S103), a processing flow 1 is implemented (Step S104). Further, when the touch panel operation conducted by the user is the multi-tapping action (Step S105), a processing flow 2 is implemented (Step S106). Still further, when the touch panel operation conducted by the user is the swiping action (Step S107), a processing flow 3 is implemented (Step S108). Yet further, when the touch panel operation conducted by the user is the pinching action (Step S109), a processing flow 4 is implemented (Step S110). The processing flow 1 through the processing flow 4 abovementioned will be detailed later on.

After the implementation of any one of the processing flow 1 through the processing flow 4 has been completed, the display image creating section 16 employs image information acquired from the data managing section 17 for creating the print image to be displayed onto the image display section 12 (Step S111). Then, the image display section 12 displays the print image onto which the print settings are reflected, thereon (Step S112).

Successively, the inputted information parsing section 13 determines whether or not the print setting operation has been completed (for instance, whether or not the OK button is depressed by the user) (Step S113), and when determining that the print setting operation has not been completed, returns to Step S101 so as to repeat the same processing. On the other hand, when the inputted information parsing section 13 determines that the print setting operation has been completed, the print information creating section 14 acquires the print setting information stored in the print setting storage section 19 so as to create the printing request based on the print setting information acquired, and then, transmits the above-created printing request to the image forming apparatus through the communication processing section 18 (Step S114). Receiving the printing request, the image forming apparatus implements the print processing operations based on the printing request so as to create the print products in conformity with the print settings established by the user.

### <Processing Flow 1>

Next, referring to the flowchart shown in FIG. 9, the processing flow 1, which is to be conducted in Step S104 shown in FIG. 8, will be detailed in the following.

At first, the inputted information parsing section 13 determines whether or not the area “a”, shown in FIG. 4, is tapped (Step S201). When determining that the area “a” is not tapped, the inputted information parsing section 13 finalizes the processing flow 1. On the other hand, when determining that the area “a” is tapped, the inputted information parsing section 13 notify the print setting managing section 15 of the operating information representing the touch panel operation. Receiving the operating information, the print setting managing section 15 specifies the touch panel operation, currently performed by the user, as the print setting operation for instructing the staple processing (single point) while referring to the correlating information stored in the setting operation storage section 21. Successively, referring to the print setting stored in the print setting storage section 19, the print setting managing section 15 determines whether the current print setting is presence or absence of the staple processing (Step S202).

Successively, when determining that the current print setting is absence of the staple processing, the print setting managing section 15 transmits the print setting information, representing the one point staple processing, to the data managing section 17. Receiving the print setting information, the data managing section 17 makes the print setting storage section 19 store the print setting information concerned, therein, (Step S203). After that, the data managing section 17 acquires the image information, corresponding to the print setting information concerned, (image data representing the image for stapling at one point) from the image resource storage section 20, and notifies the display image creating section 16 of the image information concerned (Step S204).

On the other hand, when determining that the current print setting is presence of the staple processing (in other words, when the one point staple processing has been already established), the print setting managing section 15 transmits the print setting information, representing absence of the staple processing, to the data managing section 17. Receiving the print setting information, the data managing section 17 makes the print setting storage section 19 store the print setting information concerned, therein, (Step S205). After that, the data managing section 17 acquires the image information, corresponding to the print setting information concerned, (image data representing the image of absence of the staple processing) from the image resource storage section 20, and notifies the display image creating section 16 of the image information concerned (Step S206).

### <Processing Flow 2>

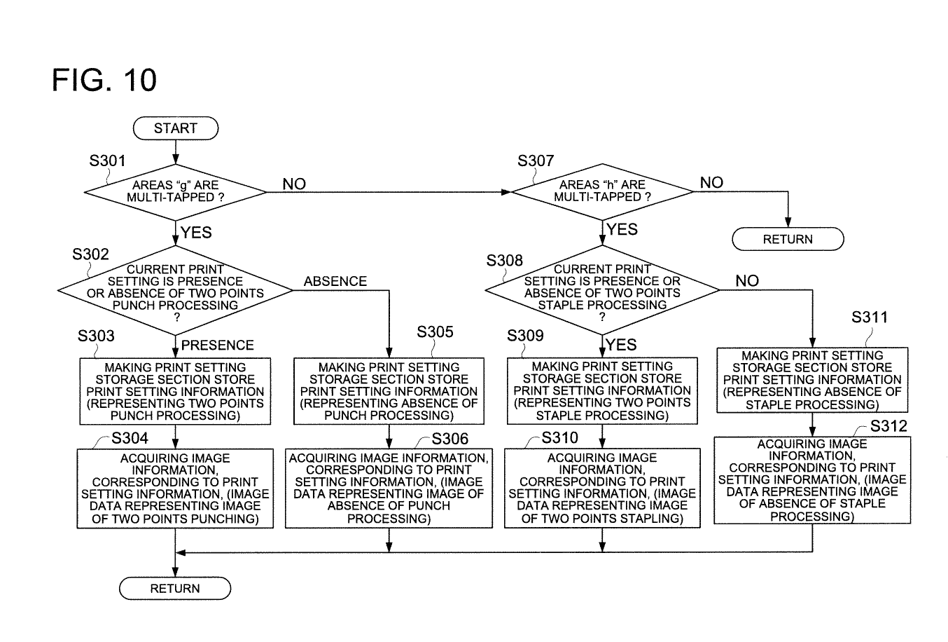

Next, referring to the flowchart shown in FIG. 10, the processing flow 2, which is to be conducted in Step S106 shown in FIG. 8, will be detailed in the following.

At first, the inputted information parsing section 13 determines whether or not the areas “g”, shown in FIG. 4, are multi-tapped (Step S301). When determining that the areas “g” are multi-tapped, the inputted information parsing section 13 notify the print setting managing section 15 of the operating information representing the touch panel operation. Receiving the operating information, the print setting managing section 15 specifies the touch panel operation, currently performed by the user, as the print setting operation for instructing the punch processing (two points) while referring to the correlating information aforementioned. Successively, referring to the print setting stored in the print setting storage section 19, the print setting managing section 15 determines whether the current print setting is presence or absence of the punch processing (Step S302).

Successively, when determining that the current print setting is absence of the punch processing, the print setting managing section 15 transmits the print setting information, representing the two points punch processing, to the data managing section 17. Receiving the print setting information, the data managing section 17 makes the print setting storage section 19 store the print setting information concerned, therein, (Step S303). After that, the data managing section 17 acquires the image information, corresponding to the print setting information concerned, (image data representing the image for punching at two points) from the image resource storage section 20, and notifies the display image creating section 16 of the image information concerned (Step S304).

On the other hand, when determining that the current print setting is presence of the punch processing (in other words, when the two points punch processing has been already established), the print setting managing section 15 transmits the print setting information, representing absence of the stapling operation, to the data managing section 17. Receiving the print setting information, the data managing section 17 makes the print setting storage section 19 store the print setting information concerned, therein, (Step S305). After that, the data managing section 17 acquires the image information, corresponding to the print setting information concerned, (image data representing the image of absence of the punch processing) from the image resource storage section 20, and notifies the display image creating section 16 of the image information concerned (Step S306).

When determining that the areas “g” are not multi-tapped in Step S301, the inputted information parsing section 13 further determines whether or not the areas “h” are multi-tapped (Step S307). When determining that the areas “h” are not multi-tapped, the inputted information parsing section 13 finalizes the processing flow 2. On the other hand, when determining that the areas “h” are multi-tapped, the inputted information parsing section 13 notify the print setting managing section 15 of the operating information representing the touch panel operation. Receiving the operating information, the print setting managing section 15 specifies the touch panel operation, currently performed by the user, as the print setting operation for instructing the two points staple processing (two points) while referring to the correlating information aforementioned. Successively, referring to the print setting stored in the print setting storage section 19, the print setting managing section 15 determines whether the current print setting is presence or absence of the staple processing (Step S308).

Successively, when determining that the current print setting is absence of the staple processing, the print setting managing section 15 transmits the print setting information, representing the two points staple processing, to the data managing section 17. Receiving the print setting information, the data managing section 17 makes the print setting storage section 19 store the print setting information concerned, therein, (Step S309). After that, the data managing section 17 acquires the image information, corresponding to the print setting information concerned, (image data representing the image for stapling at two points) from the image resource storage section 20, and notifies the display image creating section 16 of the image information concerned (Step S310).

On the other hand, when determining that the current print setting is presence of the staple processing (in other words, when the two points staple processing has been already established), the print setting managing section 15 transmits the print setting information, representing absence of the staple processing, to the data managing section 17. Receiving the print setting information, the data managing section 17 makes the print setting storage section 19 store the print setting information concerned, therein, (Step S311). After that, the data managing section 17 acquires the image information, corresponding to the print setting information concerned, (image data representing the image of absence of the staple processing) from the image resource storage section 20, and notifies the display image creating section 16 of the image information concerned (Step S312).

### <Processing Flow 3>

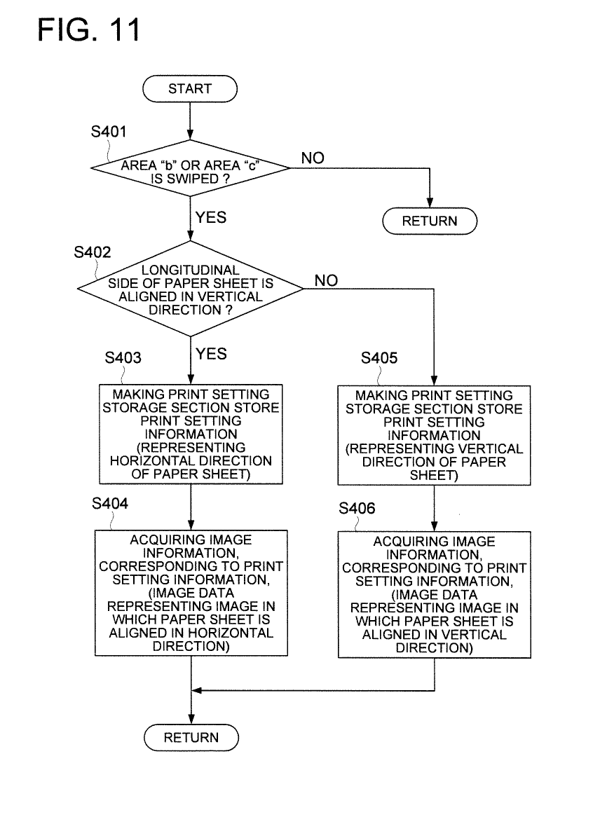

Next, referring to the flowchart shown in FIG. 11, the processing flow 3, which is to be conducted in Step S108 shown in FIG. 8, will be detailed in the following.

At first, the inputted information parsing section 13 determines whether or not the area “b” or the area “c”, shown in FIG. 4, is swiped (Step S401). When determining that neither the area “b” nor the area “c” is swiped, the inputted information parsing section 13 finalizes the processing flow 3. On the other hand, when determining that the area “b” or the area “c” is swiped, the inputted information parsing section 13 notify the print setting managing section 15 of the operating information representing the touch panel operation. Receiving the operating information, the print setting managing section 15 specifies the touch panel operation, currently performed by the user, as the print setting operation for instructing the paper-sheet direction change processing while referring to the correlating information aforementioned. Successively, referring to the print setting stored in the print setting storage section 19, the print setting managing section 15 determines whether the longitudinal side of the paper sheet, currently used, is aligned in the vertical direction or the horizontal direction (Step S402).

Successively, when determining that the longitudinal side of the paper sheet, currently used, is aligned in the vertical direction, the print setting managing section 15 transmits the print setting information, representing the paper-sheet direction change processing, to the data managing section 17. Receiving the print setting information, the data managing section 17 makes the print setting storage section 19 store the print setting information concerned, therein, (Step S403). After that, the data managing section 17 acquires the image information, corresponding to the print setting information concerned, (image data representing the image in which the paper sheet is aligned in the horizontal direction) from the image resource storage section 20, and notifies the display image creating section 16 of the image information concerned (Step S404).

On the other hand, when determining that the longitudinal side of the paper sheet, currently used, is not aligned in the vertical direction (in other words, when the longitudinal side of the paper sheet, currently used, is aligned in the horizontal direction), the print setting managing section 15 transmits the print setting information, representing the instruction for aligning the longitudinal side of the paper sheet into the vertical direction, to the data managing section 17. Receiving the print setting information, the data managing section 17 makes the print setting storage section 19 store the print setting information concerned, therein, (Step S405). After that, the data managing section 17 acquires the image information, corresponding to the print setting information concerned, (image data representing the image in which the longitudinal side of the paper sheet is aligned in the vertical direction) from the image resource storage section 20, and notifies the display image creating section 16 of the image information concerned (Step S406).

### <Processing Flow 4>

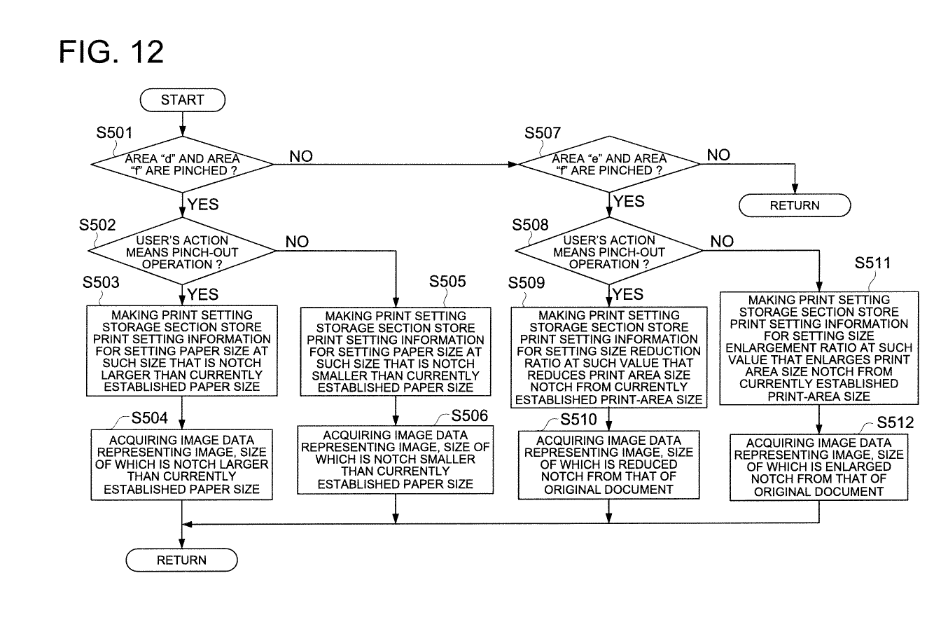

Next, referring to the flowchart shown in FIG. 12, the processing flow 4, which is to be conducted in Step S110 shown in FIG. 8, will be detailed in the following.

At first, the inputted information parsing section 13 determines whether or not the area “d” and the area “f”, shown in FIG. 4, are pinched (Step S501). When determining that the area “d” and the area “f” are pinched, the inputted information parsing section 13 determines whether or not the user's action means the pinch-out operation (Step S502).

When determining that the user's action means the pinch-out operation, the inputted information parsing section 13 notify the print setting managing section 15 of the operating information representing the pinch-out operation. Receiving the operating information, the print setting managing section 15 specifies the touch panel operation, currently performed by the user, as the print setting operation for instructing the size enlargement processing of the paper sheet while referring to the correlating information aforementioned. Successively, referring to the print setting stored in the print setting storage section 19, the print setting managing section 15 recognizes the currently established paper size, and transmits the print setting information for setting the paper size at such a size that is a notch larger than the currently established paper size, to the data managing section 17. Receiving the print setting information, the data managing section 17 makes the print setting storage section 19 store the print setting information concerned, therein, (Step S503). After that, the data managing section 17 acquires the image information, corresponding to the print setting information concerned, (image data representing the image that is a notch larger than the currently established paper size) from the image resource storage section 20, and notifies the display image creating section 16 of the image information concerned (Step S504).

On the other hand, when determining that the user's action does not mean the pinch-out operation, the inputted information parsing section 13 notify the print setting managing section 15 of the operating information representing the pinch-in operation. Receiving the operating information, the print setting managing section 15 specifies the touch panel operation, currently performed by the user, as the print setting operation for instructing the size reduction processing of the paper sheet while referring to the correlating info, illation aforementioned. Successively, referring to the print setting stored in the print setting storage section 19, the print setting managing section 15 recognizes the currently established paper size, and transmits the print setting information for setting the paper size at such a size that is a notch smaller than the currently established paper size, to the data managing section 17. Receiving the print setting information, the data managing section 17 makes the print setting storage section 19 store the print setting information concerned, therein, (Step S505). After that, the data managing section 17 acquires the image information, corresponding to the print setting information concerned, (image data representing the image that is a notch smaller than the currently established paper size) from the image resource storage section 20, and notifies the display image creating section 16 of the image information concerned (Step S506).

When determining that the area “d” and the area “f” are not pinched, the inputted information parsing section 13 determines whether or not the area “e” and the area “f” are pinched (Step S507). When determining that the area “e” and the area “f” are not pinched, the inputted information parsing section 13 finalizes the processing flow 4. On the other hand, When determining that the area “e” and the area are pinched, the inputted information parsing section 13 determines whether or not the user's action means the pinch-out operation (Step S508).

When determining that the user's action means the pinch-out operation, the inputted information parsing section 13 notify the print setting managing section 15 of the operating information representing the pinch-out operation. Receiving the operating information, the print setting managing section 15 specifies the touch panel operation, currently performed by the user, as the print setting operation for instructing the print are reduction processing while referring to the correlating information aforementioned. Successively, referring to the print setting stored in the print setting storage section 19, the print setting managing section 15 recognizes the currently established print-area size, and transmits the print setting information for setting the print-area size reduction ratio (size reduction ratio of the original document image) at such a value that reduce the size of the print area a notch from the currently established print-area size, to the data managing section 17. Receiving the print setting information, the data managing section 17 makes the print setting storage section 19 store the print setting information concerned, therein, (Step S509). After that, the data managing section 17 acquires the image information, corresponding to the print setting information concerned, (image data representing the image, the print area size of which is reduced a notch from that of the original document image) from the image resource storage section 20, and notifies the display image creating section 16 of the image information concerned (Step S510).

On the other hand, when determining that the user's action does not mean the pinch-out operation, the inputted information parsing section 13 notify the print setting managing section 15 of the operating information representing the pinch-in operation. Receiving the operating information, the print setting managing section 15 specifies the touch panel operation, currently performed by the user, as the print setting operation for instructing the print are enlargement processing while referring to the correlating information aforementioned. Successively, referring to the print setting stored in the print setting storage section 19, the print setting managing section 15 transmits the print setting information for setting the print-area size enlargement ratio at such a value that enlarges the size of the print area a notch from the currently established print-area size, to the data managing section 17. Receiving the print setting information, the data managing section 17 makes the print setting storage section 19 store the print setting information concerned, therein, (Step S511). After that, the data managing section 17 acquires the image information, corresponding to the print setting information concerned, (image data representing the image, the print area size of which is enlarged a notch from that of the original document image) from the image resource storage section 20, and notifies the display image creating section 16 of the image information concerned (Step S512).

In the foregoing, such the case, in which various kinds of the user's actions (gestures) and the print settings are correlated with each other in advance, has been detailed. It is also applicable, however, that the print instruction apparatus 10 is so constituted that the user can customize the correlations between the print settings and the user's actions (gestures) in advance. Referring to the schematic diagrams indicating the exemplified screens shown in FIG. 13a through FIG. 13d, and the flowchart shown in FIG. 14, the operation for changing the correlation will be detailed in the following.

Initially, the display image creating section 16 displays a screen, from which a print setting operation can be registered by the user, onto the image display section 12. For instance, the print image is displayed within the concerned screen, as indicated in the schematic diagram shown in FIG. 13a. Then, when the user performs a desired touch panel operation (in the schematic diagram shown in FIG. 13a, swiping the light side edge portion of the print image in the up and down direction) on the concerned screen (Step S601), the touch panel interface 11 notifies the inputted information parsing section 13 of signals outputted from the touch panel (positional information representing the position, at which the user has touched the touch panel). Receiving the signals, the inputted information parsing section 13 parses the positional information, so as to determining whether the touch panel operation, currently performed by the user, is the tapping action, the multi-tapping action, the swiping action or the pinching action (Steps S602 through S606).

Successively, the display image creating section 16 makes the image display section 12 display the confirmation dialogue as shown in FIG. 13b, and at the time when the user depresses the OK button displayed within the dialogue area, the display image creating section 16 makes the image display section 12 display the list screen of the print setting operations as shown in FIG. 13c (Step S608).

Still successively, at the time when the user selects a desired print setting operation from the list screen of the print setting operations currently displayed, the print setting managing section 15 notifies the data managing section 17 of the selected print setting operation, the kind of operation and the screen area information while correlating them with each other. Receiving the information concerned, the data managing section 17 stores the information above-correlated into the setting operation storage section 21 (Step S609).

After that, the data managing section 17 acquires image information corresponding to the print setting operation concerned (in this example, image data representing the image for punching the paper sheet at two points), so as to notify the display image creating section 16 of the image information. Receiving the image information concerned, the display image creating section 16 creates the print image based on the image information received, and makes the image display section 12 display the print image as indicated in the schematic diagram shown in FIG. 13d (Step S610).

As described in the foregoing, according to present invention, when the user performs a predetermined touch panel operation (gesture) onto the predetermined area in the print image, the print instruction apparatus specifies and stores the print setting operation corresponding to the predetermined touch panel operation performed onto the predetermined area while referring to the correlating information stored in advance, and at the same time, displays the print image after the print setting is changed, and at the time when the touch panel operation, performed by the user, is completed, creates the print request for instructing the printing operation corresponding to the print setting stored. Accordingly, it becomes possible for the user to achieve the print setting only by performing an intuitive and simple touch panel action. Further, since the user can customize the correlations between the predetermined touch panel operations (gestures), to be performed on the predetermined area, and the print settings, it becomes possible for the user to implement the print setting by performing the user's favorite touch panel operation, resulting in improvement of the usability and convenience of the user.

Incidentally, it is needless to say that the scope of the present invention is not limited to the above-exemplified embodiments. Modifications and additions, made by a skilled person without departing from the spirit and scope of the invention, shall be included in the scope of the present invention.

For instance, although the tapping action, the pinching action and swiping action have been exemplified as the touch panel operations in the embodiments described in the foregoing, the scope of the touch panel operations is not limited to the above-exemplified touch panel operations. Further, the touch panel operation for touching one point or two points has been exemplified as the touch panel operation in the embodiments described in the foregoing, the other touch panel operation for touching three points or more points is also applicable in the present invention, as well.

The present invention is available for a print instruction apparatus provided with a touch panel and a computer program to be executed by the print instruction apparatus concerned.

According to the print instruction apparatus or the non-transitory computer readable storage medium storing the print instruction program, it becomes possible for the user to conduct a print setting operation only by performing an intuitive touch panel operation onto a print image.

This is because, when the user performs a predetermined touch panel operation (gesture) onto a predetermined area located within the print image, currently displayed under the touch panel, the print instruction apparatus specifies the print setting operation corresponding to the predetermined touch panel operation performed onto the predetermined area while referring to the correlating information stored in advance, so as to update the print image to be displayed, according to the print setting concerned, and at the same time, conducts the controlling operations for generating the information for instructing the printing operation.

Therefore, according to the abovementioned features of the present invention, it becomes possible to provide such a user interface that is more intuitive and higher in its operability than ever, compared to the conventional method for displaying the print setting screen, resulting in improvement of user's convenience and usability.

While the preferred embodiments of the present invention have been described using specific term, such description is for illustrative purpose only, and it is to be understood that changes and variations may be made without departing from the spirit and scope of the appended claims.

What is claimed is:

1. A print instruction apparatus that is provided with a touch panel, comprising:
an image display section to display a print image of a document, serving as a print object, thereon;
an inputted information parsing section that parses signals outputted from the touch panel, disposed on the image display section, so as to specify a predetermined touch panel operation performed onto a predetermined area located within the print image;
a storage section to store correlating information for correlating the predetermined touch panel operation with a print setting that specifies a print condition or a finishing condition of the document, for every area correlated to the print image;
a print setting managing section to specify the print setting that corresponds to the predetermined touch panel operation, performed onto a predetermined area and specified by the inputted information parsing section, while referring to the correlating information;
a display image creating section that creates image data representing the print image, which corresponds to the print setting specified by the print setting managing section, so as to update a print image currently displayed on the image display section to the print image; and
a print information creating section to create information representing an instruction for implementing a printing operation in conformity with the pint setting specified by the print setting managing section.

2. The print instruction apparatus of claim 1,
wherein the print instruction apparatus is provided with such an operating mode in which the predetermined touch panel operation, performed onto the predetermined area located within the print image, is to be registered; and
wherein, in the operating mode, at a time when the predetermined touch panel operation is performed onto the predetermined area located within the print image:
the display image creating section makes the image display section display a list of print settings, thereon; and
the print setting managing section correlates the predetermined touch panel operation, performed onto the predetermined area, with a specific print setting selected from the list of print settings, so as to update the correlating information stored in the storage section.

3. The print instruction apparatus of claim 1,
wherein the predetermined touch panel operation, performed onto the predetermined area located within the print image, is to tap a peripheral edge side area of the print image; and
wherein the print setting, corresponding to the predetermined touch panel operation, is established as any one of stapling paper sheets at a tapped position and punching a paper sheet at a tapped position.

4. The print instruction apparatus of claim 1,
wherein the predetermined touch panel operation, performed onto the predetermined area located within the print image, is to swipe the touch panel so as to make a touched point rotate from a center of a side area of the print image, serving as an origin of rotation; and
wherein the print setting, corresponding to the predetermined touch panel operation, is established as changing a long side direction of a paper sheet.

5. The print instruction apparatus of claim 1,
wherein the predetermined touch panel operation, performed onto the predetermined area located within the print image, is to pinch an interval distance between a point, located at a center area of the print image, and another point, located at a edge portion of the print image, so as to change the interval distance pinched; and
wherein the print setting, corresponding to the predetermined touch panel operation, is established as changing a size of a paper sheet.

6. The print instruction apparatus of claim 1,
wherein the print image includes a document printing area within which the document is to be printed and a blank area located in periphery of the document printing area
wherein the predetermined touch panel operation, performed onto the predetermined area located within the print image, is to pinch an interval distance between a point, located at a edge portion of the print image, and another point, located at the blank area in a vicinity of the edge portion, so as to change the interval distance pinched; and
wherein the print setting, corresponding to the predetermined touch panel operation, is established as changing the document printing area within which the document is to be printed.

7. The print instruction apparatus of claim 1,
wherein the predetermined touch panel operation, performed onto the predetermined area located within the print image, is to swipe the print image so as to make the print image split in either a horizontal direction or a vertical direction; and
wherein the print setting, corresponding to the predetermined touch panel operation, is established as an N-in-1 setting in which a plurality of pages is arranged into a single paper sheet.

8. The print instruction apparatus of claim 7,
wherein another predetermined touch panel operation, performed onto the predetermined area located within the print image, is to swipe the plurality of pages arranged into the single paper sheet; and
wherein the print setting, corresponding to the other predetermined touch panel operation, is established as a page allotment setting in which an arrangement order of the plurality of pages is made to change in accordance to an order of swiping the plurality of pages.

9. The print instruction apparatus of claim 1,
wherein the predetermined touch panel operation, performed onto the predetermined area located within the print image, is to swipe the print image so as to make the print image split in a short side direction of the print image; and
wherein the print setting, corresponding to the predetermined touch panel operation, is established as folding a paper sheet along a swiped line.

10. The print instruction apparatus of claim 1,
wherein the predetermined touch panel operation, performed onto the predetermined area located within the print image, is to swipe the print image along a side line of the print image; and
wherein the print setting, corresponding to the predetermined touch panel operation, is established as generating a binding margin along the side line swiped.

11. A non-transitory computer readable storage medium storing a computer executable program to be executed in an apparatus that is provided with a touch panel mounted onto an image display section to display a print image of a document, serving as a print object, thereon, the program being executable by a computer to cause the computer to perform a process comprising:
parsing signals outputted from the touch panel, so as to specify a predetermined touch panel operation performed onto a predetermined area located within the print image;
referring to correlating information, stored in advance, for correlating the predetermined touch panel operation with a print setting that specifies a print condition or a finishing condition of the document, for every area correlated to the print image, so as to specify the print setting that corresponds to the predetermined touch panel operation, performed onto a predetermined area and specified in the above; and
creating image data representing the print image, which corresponds to the print setting above-specified, so as to update a print image currently displayed on the image display section to the print image; and
creating information representing an instruction for implementing a printing operation in conformity with the print setting specified in the above.

12. The non-transitory computer readable storage medium of claim 11,
wherein the apparatus is provided with such an operating mode in which the predetermined touch panel operation, performed onto the predetermined area located within the print image, is to be registered; and,
in the operating mode, at a time when the predetermined touch panel operation is performed onto the predetermined area located within the print image, the process further comprising:
making the image display section display a list of print settings, thereon; and
correlating the predetermined touch panel operation, performed onto the predetermined area, with a specific print setting selected from the list of print settings, so as to update the correlating information stored in advance.
